(19) United States
(12) Patent Application Publication
(10) Pub. No.: US 2026/0320336 A1
(43) Pub. Date: Oct. 15, 2026

(54) TIRE MANAGEMENT DEVICE AND TIRE MANAGEMENT METHOD

(71) Applicant: BRIDGESTONE CORPORATION, Chuo-ku, Tokyo (JP)

(72) Inventors: Takehito KAMADA, Chuo-ku, Tokyo (JP); Yujiro ITO, Chuo-ku, Tokyo (JP); Hironori HOSHINO, Chuo-ku, Tokyo (JP)

(73) Assignee: BRIDGESTONE CORPORATION, Chuo-ku, Tokyo (JP)

(21) Appl. No.: 19/137,397

(22) PCT Filed: Oct. 30, 2023
(86) PCT No.: PCT/JP2023/039106

§ 371 Date: Jun. 10, 2025

(30) Foreign Application Priority Data
Dec. 16, 2022 (JP) 2022-201546

(51) Int. Cl. G06K 19/07; B60C 19/00; G06K 7/10

(52) U.S. Cl. CPC G06K 19/0723; G06K 7/10297; B60C 19/00; B60C 2019/004; B60C 2200/065

(57) ABSTRACT

A tire management device (10) is a tire management device configured to manage tires having transmitters (31) built in, the tire management device comprising: an acquisition unit (131) configured to acquire transmitter ID information read from each transmitter built in an operation target tire that is to be subjected to an operation among the tires, and tire management data including tire ID information of each tire associated with transmitter ID information; and a determination unit (132) configured to, in the case where a plurality of pieces of transmitter ID information are acquired, determine that there is no confusion if all pieces of tire ID information associated with the plurality of pieces of transmitter ID information match, and determine that there is confusion if not all pieces of tire ID information associated with the plurality of pieces of transmitter ID information match.

### TECHNICAL FIELD

The present disclosure relates to a tire management device and a tire management method.

### BACKGROUND

In recent years, electronic devices such as transmitters are sometimes attached to tires for individual tire identification and the like. As a result of making individual tires identifiable, tire inventory management and monitoring can be performed accurately. For example, Patent Literature (PTL) 1 discloses a tire having an RFID tag placed in a peripheral region of a bead core, which enables traceability even in the event of tire damage.

### CITATION LIST

### Patent Literature

PTL 1: JP 2020-79042 A

### SUMMARY

### Technical Problem

Information is read from an RFID tag through short-range wireless communication with a reader device. Accordingly, large-sized tires such as off the road (OR) tires used on construction vehicles, etc. may have a plurality of RFID tags built in so that information can be read by a reader device fixed to equipment, for example. While this enhances the ease of reading information, confusion may occur when the reader device acquires information of a plurality of RFID tags. In detail, with conventional technology, it is difficult to determine whether the information of the plurality of RFID tags concerns one tire or includes information from another tire.

It could therefore be helpful to provide a tire management device and tire management method that can determine whether there is confusion over information obtained from a tire having one or more built-in transmitters.

### Solution to Problem

(1) A tire management device according to one embodiment of the present disclosure is a tire management device configured to manage tires having transmitters built in, the tire management device comprising: an acquisition unit configured to acquire transmitter ID information read from each transmitter built in an operation target tire that is to be subjected to an operation among the tires, and tire management data including tire ID information of each tire associated with transmitter ID information; and a determination unit configured to, in the case where a plurality of pieces of transmitter ID information are acquired, determine that there is no confusion if all pieces of tire ID information associated with the plurality of pieces of transmitter ID information match, and determine that there is confusion if not all pieces of tire ID information associated with the plurality of pieces of transmitter ID information match.
(2) As one embodiment of the present disclosure, in (1), the acquisition unit is configured to acquire data of a number of transmitters according to tire type, and the determination unit is configured to determine that there is confusion if a number of pieces of transmitter ID information acquired is more than a number of transmitters corresponding to a type of the operation target tire.
(3) A tire management device according to one embodiment of the present disclosure is a tire management device configured to manage tires having transmitters built in, the tire management device comprising: an acquisition unit configured to acquire transmitter ID information read from each transmitter built in an operation target tire that is to be subjected to an operation among the tires, and tire management data including tire ID information of each tire associated with transmitter ID information; and a determination unit configured to, in the case where a plurality of pieces of transmitter ID information are acquired, determine that there is no confusion if all pieces of tire ID information associated with the plurality of pieces of transmitter ID information match, and determine that there is confusion if not all pieces of tire ID information associated with the plurality of pieces of transmitter ID information match and the pieces of tire ID information do not include tire ID information detected a larger number of times.
(4) As one embodiment of the present disclosure, in (3), the determination unit is configured to determine that the operation target tire is a tire having the tire ID information detected the larger number of times, if not all pieces of tire ID information associated with the plurality of pieces of transmitter ID information match and the pieces of tire ID information include the tire ID information detected the larger number of times.
(5) As one embodiment of the present disclosure, in (3) or (4), the acquisition unit is configured to acquire data of a number of transmitters according to tire type, and the determination unit is configured to determine that there is confusion if a number of pieces of transmitter ID information acquired is more than a number of transmitters corresponding to a type of the operation target tire.
(6) A tire management method according to one embodiment of the present disclosure is a tire management method executed by a tire management device that manages tires having transmitters built in, the tire management method comprising: acquiring transmitter ID information read from each transmitter built in an operation target tire that is to be subjected to an operation among the tires, and tire management data including tire ID information of each tire associated with transmitter ID information; and in the case where a plurality of pieces of transmitter ID information are acquired, determining that there is no confusion if all pieces of tire ID information associated with the plurality of pieces of transmitter ID information match, and determining that there is confusion if not all pieces of tire ID information associated with the plurality of pieces of transmitter ID information match.
(7) A tire management method according to one embodiment of the present disclosure is a tire management method executed by a tire management device that manages tires having transmitters built in, the tire management method comprising: acquiring transmitter ID information read from each transmitter built in an operation target tire that is to be subjected to an operation among the tires, and tire management data including tire ID information of each tire associated with transmitter ID information; and in the case where a plurality of pieces of transmitter ID information are acquired, determining that there is no confusion if all pieces of tire ID information associated with the plurality of pieces of transmitter ID information match, and determining that there is confusion if not all pieces of tire ID information associated with the plurality of pieces of transmitter ID information match and the pieces of tire ID information do not include tire ID information detected a larger number of times.

### Advantageous Effect

It is thus possible to provide a tire management device and tire management method that can determine whether there is confusion over information obtained from a tire having one or more built-in transmitters.

### BRIEF DESCRIPTION OF THE DRAWINGS

In the accompanying drawings:

FIG. 1 is a diagram illustrating an example of the structure of a tire management system including a tire management device according to one embodiment of the present disclosure;

FIG. 2 is a diagram for explaining tire management data;

FIG. 3 is a diagram illustrating an example of data of the number of transmitters according to tire type;

FIG. 4 is a diagram for explaining inconsistency due to confusion;

FIG. 5 is a flowchart illustrating an example of processing of a tire management method executed by the tire management device; and

FIG. 6 is a flowchart illustrating another example of processing of the tire management method executed by the tire management device.

### DETAILED DESCRIPTION

A tire management device and tire management method according to one embodiment of the present disclosure will be described below with reference to the drawings. In the drawings, the same or corresponding parts are given the same reference signs. In the description of this embodiment, the description of the same or corresponding parts will be omitted or simplified as appropriate.

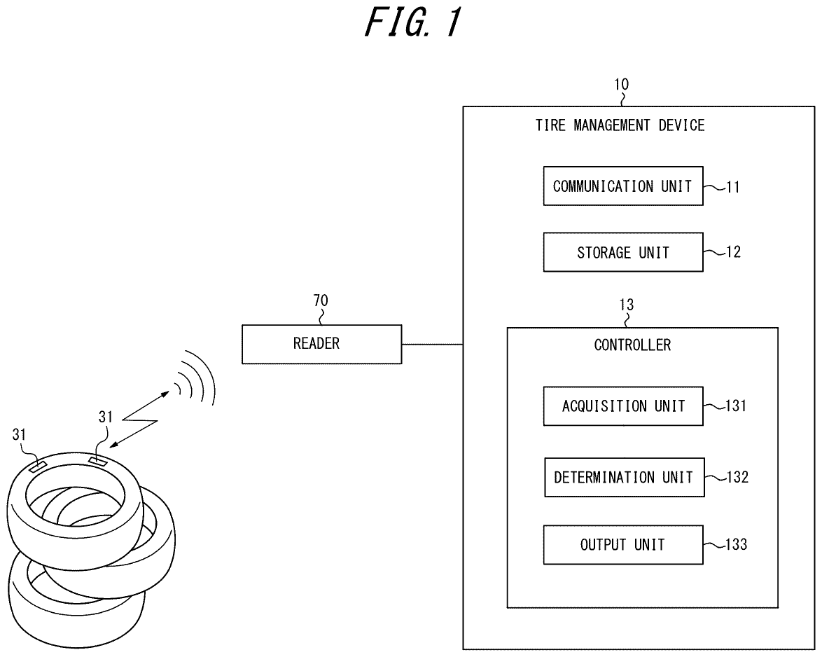

FIG. 1 illustrates an example of the structure of a tire management system including a tire management device 10 according to this embodiment. The tire management device 10 manages tires. Specifically, the tire management device 10 manages information about the state and distribution of each tire. The tires managed by the tire management device 10 are not limited to specific ones, but include large-sized OR tires in this embodiment. The tires are for vehicles such as passenger vehicles, trucks, buses, and construction vehicles, but may also be for aircraft.

The tire management device 10 includes a communication unit 11, a storage unit 12, and a controller 13. The controller 13 includes an acquisition unit 131, a determination unit 132, and an output unit 133. The tire management device 10 may be, for example, a computer as a hardware structure. The components of the tire management device 10 will be described in detail later.

In this embodiment, the tire management device 10 is a computer at a site where a predetermined operation is performed on tires having built-in transmitters 31 (hereinafter, “operation site”). In the following description, the predetermined operation is assumed to be a tire shipping operation. The predetermined operation is, however, not limited to such, and may be, for example, an operation of a dealer receiving tires, an operation of repairing damage to tires, or an operation of sending tires to an inspection site for inspection. After the predetermined operation is performed on a tire, the tire management device 10 updates information indicating the state of the tire to manage the tire. In this embodiment, in the case where the shipping operation has been completed properly, the tire management device 10 sets the state item in the below-described tire management data to “shipped”. Here, if it is possible to write information to the transmitter 31, the tire management device 10 may write the transmitter 31 so that the state of the tire held in the transmitter 31 will be “shipped”. The tire to be subjected to the predetermined operation at the operation site is hereinafter referred to as “operation target tire”.

A reader 70 is a device that reads transmitter ID information from each transmitter 31 attached to each tire. The transmitter ID information is identification information unique to each transmitter. The tire management device 10 forms the tire management system together with at least the reader 70. One or more devices (hereinafter, “external devices”) other than the tire management device 10 may be installed at the operation site. The tire management device 10 may form the tire management system also together with one or more external devices connected via a network. The network is, for example, the Internet. The network may also include a local area network (LAN) in part. The external devices may include, for example, a device that writes information to the transmitter 31. The external devices may include, for example, a belt conveyor that transports a plurality of tires together to the site where the predetermined operation is performed.

The transmitter 31 is built in (included in) the tire. Examples of building the transmitter 31 in the tire include embedding the transmitter 31 inside the tire and attaching the transmitter 31 to the inner surface of the tire. The transmitter 31 may be attached to any surface, other than the inner surface of the tire, where the transmitter 31 is hard to detach from the tire and is unaffected by contact between the tire and the road surface. The transmitter 31 transmits a predetermined signal. The predetermined signal includes at least the transmitter ID information. The predetermined signal may further include production information of the tire to which the transmitter 31 is attached, such as production date and production place. The transmitter 31 may be an RFID tag as in this embodiment, but is not limited to a specific type of device as long as it transmits the predetermined signal. The RFID tag exchanges information with a reader device by wireless communication over a short distance (about several centimeters to several meters) using electromagnetic fields, radio waves, etc. In this embodiment, the reader 70 is an RFID tag reader device. The number of transmitters 31 built in the tire may be one or more. As mentioned above, the operation target tires include OR tires. Large-sized tires such as OR tires have a plurality of built-in RFID tags so that information can be read by a reader device fixed to equipment.

In the tire management system, the tire management device 10 may be integrated with one or more external devices. For example, the tire management device 10 may be configured to control not only the reader 70 but also a device that writes information to the transmitter 31. The tire management device 10 may be capable of communicating with a small computer device and the like via the network and may display, on a display of the small computer device, information that the shipping operation for the operation target tire has been completed. Examples of the small computer device include mobile terminals such as smartphones and tablet terminals.

The components of the tire management device 10 will be described in detail below. The communication unit 11 includes one or more communication modules connected to the network. The communication unit 11 may include, for example, a communication module compatible with a mobile communication standard such as 4G (4th Generation) or 5G (5th Generation). The communication unit 11 may include, for example, a communication module compatible with a wireless LAN standard (e.g. IEEE 802.11). The communication unit 11 may include, for example, a communication module compatible with a wired LAN standard.

The storage unit 12 is at least one memory. Examples of the memory include a semiconductor memory, a magnetic memory, and an optical memory, but the memory is not limited to such and may be any memory. The storage unit 12 is included in the tire management device 10, for example. Alternatively, the storage unit 12 may be an external storage accessed by the tire management device 10 via any interface.

The storage unit 12 stores various data used in various calculations executed by the controller 13. The storage unit 12 may also store results and intermediate data of various calculations executed by the controller 13.

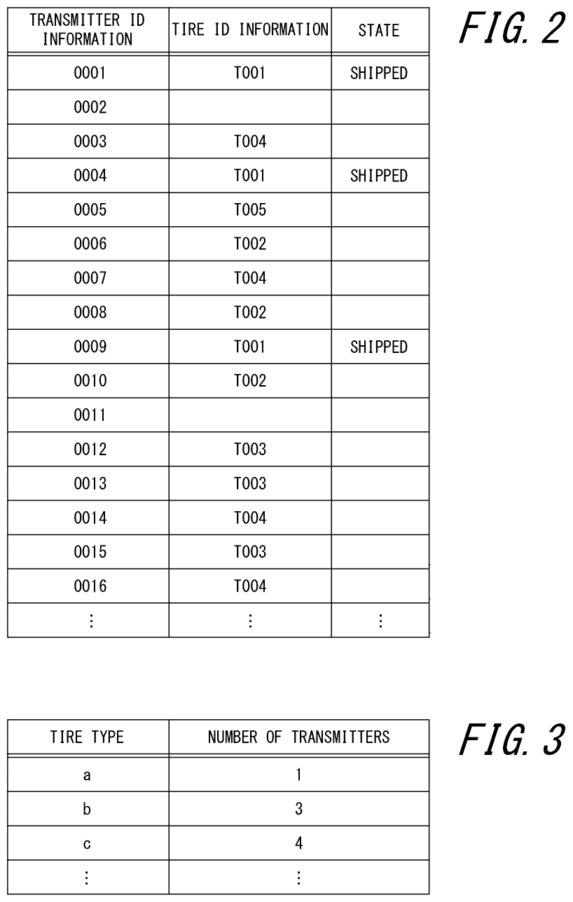

In this embodiment, the storage unit 12 stores tire management data including tire ID information of each tire associated with transmitter ID information. The tire ID information is identification information unique to each tire. FIG. 2 illustrates an example of the tire management data. In the example in FIG. 2, the tire management data is a table indicating the correspondence between transmitter ID information and tire ID information. In the example in FIG. 2, tires with tire ID information T001 to T005 are present. For example, the tire with tire ID information T005 has one built-in RFID tag with transmitter ID information 0005, and the tire with tire ID information T001 has three built-in RFID tags with transmitter ID information 0001, 0004, and 0009. RFID tags with transmitter ID information 0002 and 0011 are unused or unusable, and their fields are blank because they are not associated with any tire ID information.

In the case where a new transmitter 31 is built into a tire as a result of production, repair, or the like, the tire ID information of the tire is associated with the transmitter ID information of the new transmitter 31. The tire management data may be updated periodically or non-periodically, for example. For example, the tire management device 10 may access a computer that manages the production process of building transmitters 31 into tires via a network and obtain information of association between transmitter ID information and tire ID information.

The tire management data may include a state item. In the case where the shipping operation has been completed properly, the tire management device 10 sets the state item to “shipped”. In the example in FIG. 2, in the case where the tire ID information of the operation target tire is T001 and the shipping operation has been completed, all of the corresponding state items are set to “shipped”. The tire management data is not limited to the form, etc. illustrated in FIG. 2, and for example, another item (e.g. tire type) may be added.

The storage unit 12 may store data of the number of transmitters according to tire type. FIG. 3 is a diagram illustrating an example of the data of the number of transmitters. In the example in FIG. 3, the data of the number of transmitters is a table indicating the correspondence between the tire type and the number of transmitters 31 built in the tire. In the example in FIG. 3, a tire of type a has one transmitter 31 built in at the time of production. A tire of type b has three transmitters 31 built in at the time of production. A tire of type c has four transmitters 31 built in at the time of production. A tire of type a may be, for example, a tire for passenger vehicles. A tire of type b may be, for example, an OR tire less than or equal to a predetermined size. A tire of type c may be, for example, an OR tire greater than the predetermined size.

The controller 13 is at least one processor. Examples of the processor include a general-purpose processor and a dedicated processor specialized for specific processing, but the processor is not limited to such and may be any processor. The controller 13 controls the overall operation of the tire management device 10.

The tire management device 10 may have the following software structure. At least one program used for controlling the operation of the tire management device 10 is stored in the storage unit 12. When the program stored in the storage unit 12 is read by the processor in the controller 13, the program causes the processor to function as the acquisition unit 131, the determination unit 132, and the output unit 133.

The acquisition unit 131 acquires transmitter ID information read from each transmitter 31 built in an operation target tire which is to be subjected to the operation among the tires. In other words, the acquisition unit 131 acquires the transmitter ID information of each transmitter 31 built in the operation target tire, which has been read by the reader 70. The acquisition unit 131 also acquires the tire management data. The acquisition unit 131 may also acquire the data of the number of transmitters according to tire type.

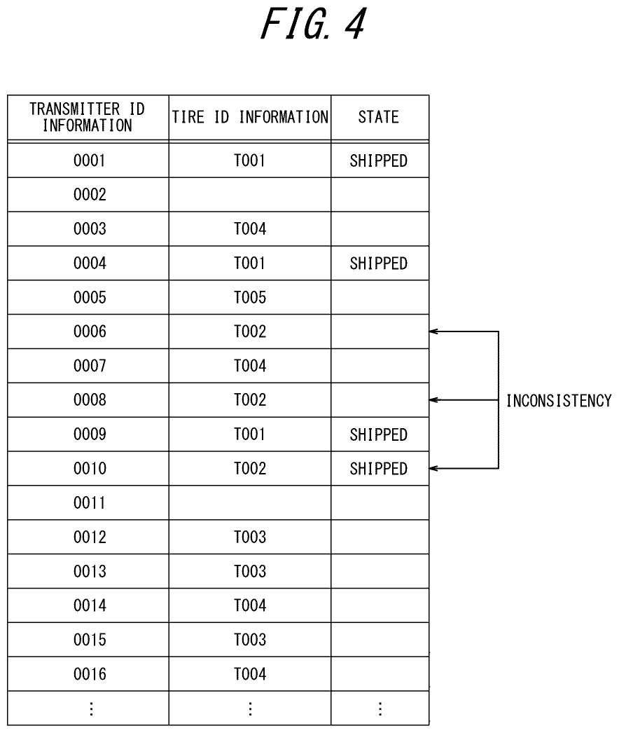

For example, in the case where the operation target tire is a large-sized tire such as an OR tire, the reader 70 may read a plurality of pieces of transmitter ID information. Here, confusion may occur, for example, when the reader 70 reads transmitter ID information while a plurality of tires are being transported together. The confusion is that a plurality of pieces of transmitter ID information that are supposed to be from the operation target tire include transmitter ID information of an RFID tag built in a tire different from (other than) the operation target tire. If the shipping operation is completed without detecting such confusion, state inconsistency occurs and the tires cannot be managed properly. FIG. 4 is a diagram for explaining inconsistency due to confusion. Each item in FIG. 4 is the same as in FIG. 2. In the example in FIG. 4, confusion occurs in which, when the tire ID information of the operation target tire is T001, transmitter ID information related to a tire with tire ID information T002 is also read. If the shipping operation is completed without detecting the confusion, information that the shipping operation has been completed and information that the shipping operation has not been completed will end up coexisting for the tire with tire ID information T002, causing inconsistency in tire management. In this embodiment, the determination unit 132 determines whether there is confusion by the process described below.

The determination unit 132 determines that there is no confusion if a plurality of pieces of transmitter ID information are acquired and all pieces of tire ID information associated with the plurality of pieces of transmitter ID information match. Take, for example, three pieces of transmitter ID information. In the case where all three pieces of tire ID information associated with the three pieces of transmitter ID information are T001, all pieces of tire ID information match. In the case where two pieces of tire ID information are T001 and one piece of tire ID information is T002, not all pieces of tire ID information match. The determination unit 132 determines that there is confusion if a plurality of pieces of transmitter ID information are acquired and not all pieces of tire ID information associated with the plurality of pieces of transmitter ID information match. If there is confusion, a warning may be output as described later. This process makes it possible to determine whether there is confusion over information obtained from a tire having built-in transmitters 31.

If confusion occurs, the number of times one tire ID information is detected and the number of times another tire ID information is detected may be different. Usually, the number of times the tire ID information of the operation target tire is detected is likely to be larger than the number of times the tire ID information of a tire different from the operation target tire is detected. If a plurality of pieces of transmitter ID information are acquired, not all pieces of tire ID information associated with the plurality of pieces of transmitter ID information match, and the pieces of tire ID information include tire ID information detected a larger number of times, the determination unit 132 may determine that the operation target tire is a tire having the tire ID information detected a larger number of times. For example, if, among pieces of tire ID information associated with three pieces of transmitter ID information, two pieces of tire ID information are T001 and one piece of tire ID information is T002, the determination unit 132 determines that the tire ID information of the operation target tire is T001. This process allows the operation target tire to be appropriately identified even when there is confusion.

In the above-described case of determining the operation target tire to be the tire having the tire ID information detected a larger number of times, if there is no difference in the number of times tire ID information is detected, a warning may be output after the determination unit 132 determines that there is confusion. In detail, if a plurality of pieces of transmitter ID information are acquired, not all pieces of tire ID information associated with the plurality of pieces of transmitter ID information match, and the pieces of tire ID information do not include tire ID information detected a larger number of times, the determination unit 132 determines that there is confusion. If a plurality of pieces of transmitter ID information are acquired and all pieces of tire ID information associated with the plurality of pieces of transmitter ID information match, the determination unit 132 determines that there is no confusion. This process makes it possible to determine whether there is confusion over information obtained from a tire having built-in transmitters 31.

Here, the determination unit 132 may further perform determination based on the operation target tire and the number of transmitters. The determination unit 132 may determine that there is confusion if the number of pieces of transmitter ID information acquired is more than the number of transmitters corresponding to the type of the operation target tire. In the example in FIG. 3, when the type of the operation target tire is “b”, the determination unit 132 may immediately determine that there is confusion if the number of pieces of transmitter ID information acquired is more than 3. This process makes it possible to more reliably determine whether there is confusion.

The output unit 133 outputs the result of determination by the determination unit 132 to a display device or the like. For example, a display connected to the tire management device 10 can function as a display device that displays the determination result.

The result output by the output unit 133 is not limited to whether there is confusion. In this embodiment, a warning is output when there is confusion. Examples of the warning include a warning requesting redoing of the shipping operation and a warning requesting stopping writing “shipped” as the state. The worker at the operation site can promptly take appropriate action in accordance with such a warning.

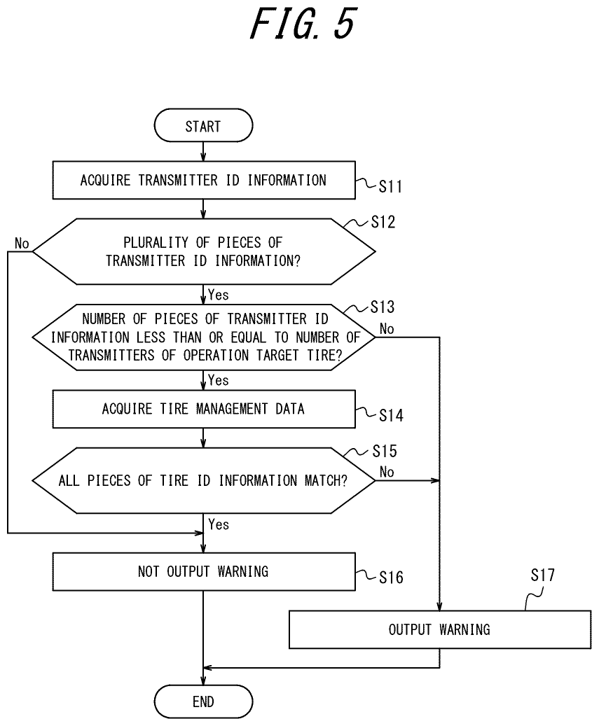

FIG. 5 is a flowchart illustrating an example of processing of a tire management method executed by the controller 13 in the tire management device 10. The processing of the tire management method may be started at the timing of performing the shipping operation on the operation target tire.

The acquisition unit 131 acquires transmitter ID information read from each transmitter 31 built in the operation target tire (step S11). The acquisition unit 131 may also acquire the data of the number of transmitters according to tire type.

If a plurality of pieces of transmitter ID information are not acquired (step S12: No), the processing proceeds to step S16 without the determination unit 132 performing confusion determination. The output unit 133 then does not output a warning, and the processing ends. If a plurality of pieces of transmitter ID information are acquired (step S12: Yes), the processing proceeds to step S13.

If the number of pieces of transmitter ID information acquired is more than the number of transmitters corresponding to the type of the operation target tire (step S13: No), the determination unit 132 determines that there is confusion. The output unit 133 then outputs a warning (step S17). If the number of pieces of transmitter ID information acquired is less than or equal to the number of transmitters corresponding to the type of the operation target tire (step S13: Yes), the determination unit 132 proceeds with the confusion determination and the processing proceeds to step S14. Step S13 may be omitted in the case where the determination unit 132 does not perform the determination based on the number of transmitters.

The acquisition unit 131 acquires the tire management data (step S14). The determination unit 132 can obtain tire ID information associated with each of the plurality of pieces of transmitter ID information based on the tire management data.

If a plurality of pieces of transmitter ID information are acquired and all pieces of tire ID information associated with the plurality of pieces of transmitter ID information match (step S15: Yes), the determination unit 132 determines that there is no confusion. The output unit 133 then does not output a warning (step S16). The determination unit 132 sets the state item in the tire management data to “shipped”, for example, and completes the shipping operation for the operation target tire.

If a plurality of pieces of transmitter ID information are acquired and not all pieces of tire ID information associated with the plurality of pieces of transmitter ID information match (step S15: No), the determination unit 132 determines that there is confusion. The output unit 133 then outputs a warning (step S17).

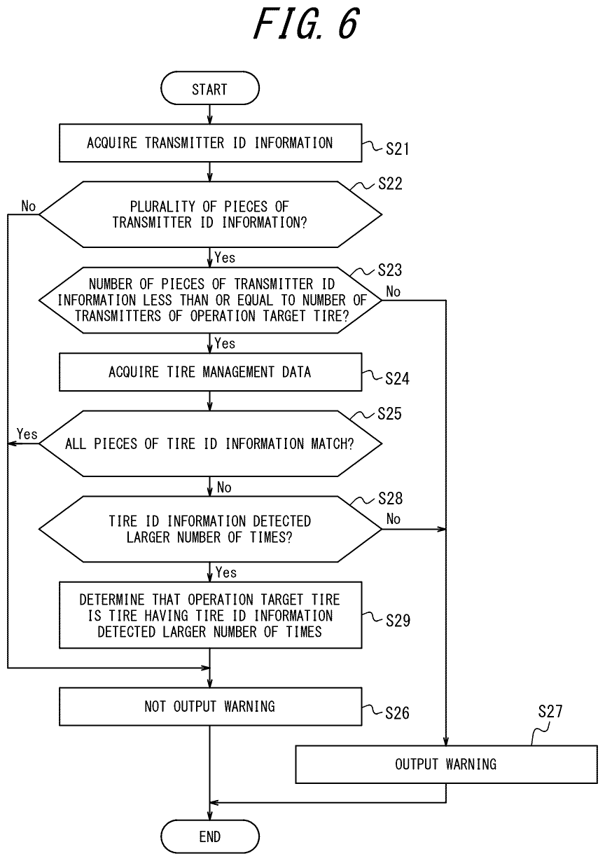

FIG. 6 is a flowchart illustrating another example of processing of the tire management method executed by the controller 13 in the tire management device 10. The controller 13 in the tire management device 10 may execute the processing in FIG. 6 instead of the processing in FIG. 5. Steps S21 to S24 in FIG. 6 are the same as steps S11 to S14 in FIG. 5 respectively, and accordingly their description will be omitted. If the determination unit 132 determines that there is confusion based on the number of pieces of transmitter ID information acquired (step S23: No), the output unit 133 outputs a warning (step S27).

If a plurality of pieces of transmitter ID information are acquired and all pieces of tire ID information associated with the plurality of pieces of transmitter ID information match (step S25: Yes), the determination unit 132 determines that there is no confusion. The output unit 133 then does not output a warning (step S26). The determination unit 132 sets the state item in the tire management data to “shipped”, for example, and completes the shipping operation for the operation target tire.

If a plurality of pieces of transmitter ID information are acquired and not all pieces of tire ID information associated with the plurality of pieces of transmitter ID information match (step S25: No), the processing proceeds to step S28. If the pieces of tire ID information include tire ID information detected a larger number of times (step S28: Yes), the determination unit 132 determines that the operation target tire is a tire having the tire ID information detected a larger number of times (step S29). The output unit 133 then does not output a warning (step S26). The determination unit 132 sets the state item in the tire management data to “shipped”, for example, and completes the shipping operation for the operation target tire.

If the pieces of tire ID information do not include tire ID information detected a larger number of times (step S28: No), the determination unit 132 determines that there is confusion that makes it impossible to identify the operation target tire. The output unit 133 then outputs a warning (step S27).

As another example, the controller 13 in the tire management device 10 may selectively execute the processing of the flowchart in FIG. 5 and the processing of the flowchart in FIG. 6. The processing of the flowchart in FIG. 6 is based on the premise that there may be a difference in the number of times tire ID information is detected. Accordingly, the controller 13 in the tire management device 10 may determine whether the number of pieces of transmitter ID information acquired is three or more. For example, the determination of whether the number of pieces of transmitter ID information acquired is three or more may be performed immediately before the process of acquiring the tire management data (step S14 or S24). If the number of pieces of transmitter ID information acquired is three or more, the processing of the flowchart in FIG. 6 (steps S24 to S27) may be performed. If the number of pieces of transmitter ID information acquired is two, the processing of the flowchart in FIG. 5 (steps S14 to S17) may be performed.

As described above, the tire management device 10 and the tire management method according to this embodiment with the foregoing structure can, even when a tire has a plurality of built-in transmitters, determine whether there is confusion over information obtained from the tire having built-in transmitters.

Although an embodiment of the present disclosure has been described by way of the drawings and examples, various changes or modifications may be easily made by those of ordinary skill in the art based on the present disclosure. Such various changes or modifications are therefore included in the scope of the present disclosure. For example, the functions included in the components, steps, etc. may be rearranged without logical inconsistency, and a plurality of components, steps, etc. may be combined into one component, step, etc. and a component, step, etc. may be divided into a plurality of components, steps, etc. The embodiment of the present disclosure can also be implemented as a program executed by a processor included in a device or a storage medium storing such a program, which are also included in the scope of the present disclosure.

### REFERENCE SIGNS LIST

10 tire management device
11 communication unit
12 storage unit
13 controller
31 transmitter
70 reader
131 acquisition unit
132 determination unit
133 output unit

1. A tire management device configured to manage tires having transmitters built in, the tire management device comprising:
an acquisition unit configured to acquire transmitter ID information read from each transmitter built in an operation target tire that is to be subjected to an operation among the tires, and tire management data including tire ID information of each tire associated with transmitter ID information; and
a determination unit configured to, in the case where a plurality of pieces of transmitter ID information are acquired, determine that there is no confusion if all pieces of tire ID information associated with the plurality of pieces of transmitter ID information match, and determine that there is confusion if not all pieces of tire ID information associated with the plurality of pieces of transmitter ID information match.

2. The tire management device according to claim 1, wherein the acquisition unit is configured to acquire data of a number of transmitters according to tire type, and
the determination unit is configured to determine that there is confusion if a number of pieces of transmitter ID information acquired is more than a number of transmitters corresponding to a type of the operation target tire.

3. A tire management device configured to manage tires having transmitters built in, the tire management device comprising:
an acquisition unit configured to acquire transmitter ID information read from each transmitter built in an operation target tire that is to be subjected to an operation among the tires, and tire management data including tire ID information of each tire associated with transmitter ID information; and
a determination unit configured to, in the case where a plurality of pieces of transmitter ID information are acquired, determine that there is no confusion if all pieces of tire ID information associated with the plurality of pieces of transmitter ID information match, and determine that there is confusion if not all pieces of tire ID information associated with the plurality of pieces of transmitter ID information match and the pieces of tire ID information do not include tire ID information detected a larger number of times.

4. The tire management device according to claim 3, wherein the determination unit is configured to determine that the operation target tire is a tire having the tire ID information detected the larger number of times, if not all pieces of tire ID information associated with the plurality of pieces of transmitter ID information match and the pieces of tire ID information include the tire ID information detected the larger number of times.

5. The tire management device according to claim 3, wherein the acquisition unit is configured to acquire data of a number of transmitters according to tire type, and
the determination unit is configured to determine that there is confusion if a number of pieces of transmitter ID information acquired is more than a number of transmitters corresponding to a type of the operation target tire.

6. A tire management method executed by a tire management device that manages tires having transmitters built in, the tire management method comprising:
acquiring transmitter ID information read from each transmitter built in an operation target tire that is to be subjected to an operation among the tires, and tire management data including tire ID information of each tire associated with transmitter ID information; and
in the case where a plurality of pieces of transmitter ID information are acquired, determining that there is no confusion if all pieces of tire ID information associated with the plurality of pieces of transmitter ID information match, and determining that there is confusion if not all pieces of tire ID information associated with the plurality of pieces of transmitter ID information match.

7. (canceled)

8. The tire management device according to claim 4, wherein the acquisition unit is configured to acquire data of a number of transmitters according to tire type, and
the determination unit is configured to determine that there is confusion if a number of pieces of transmitter ID information acquired is more than a number of transmitters corresponding to a type of the operation target tire.
